(19) United States
(12) Patent Application Publication
(10) Pub. No.: US 2026/0024462 A1
(43) Pub. Date: Jan. 22, 2026

(54) AI-DRIVEN ASSESSMENT OF STATEMENT TRUTHFULNESS USING INTEGRATED PROGRAMMATIC CONTROL AND SPECIALIZED GUIDED AND CONSTRAINED ARTIFICIAL INTELLIGENCE

(71) Applicant: 2hr Learning, Inc., Austin, TX (US)

(72) Inventors: Akshay Mate, Nanaimo (CA); Janet Demir, Ortaca (TR); Niraj Patel, Dubai (AE); Pranav Kalyan, Austin, TX (US); Sean Carlson, Austin, TX (US)

(73) Assignee: 2hr Learning, Inc., Austin, TX (US)

(21) Appl. No.: 19/273,081

(22) Filed: Jul. 17, 2025

Related U.S. Application Data
(60) Provisional application No. 63/672,423, filed on Jul. 17, 2024.

(51) Int. Cl. G09B 19/00; G06F 40/30; H04N 21/854

(52) U.S. Cl. CPC G09B 19/0046; G06F 40/30; H04N 21/854

(57) ABSTRACT

A system and method for guiding an artificial intelligence (AI) engine to generate an assessment of statement truthfulness receives input data from a main data model containing educational standards and course information, and a Truth or Lies (TOL) data model containing information about historical figures. Based on the user-provided course ID and standard ID, relevant data is selected and retrieved from the main data model and the TOL data model. A prompt generator creates prompts to guide an AI engine in generating educational statements, including both true and false statements. The system and method for guiding an AI engine to generate an assessment of statement truthfulness integrates image generation to produce visuals corresponding to the statements and employs video generation and voice synthesis models to create video responses featuring historical figures explaining the statements.

### CROSS-REFERENCE TO RELATED APPLICATION(S)

This application claims the benefit under 35 U.S.C. § 119 (c) and 37 C.F.R. § 1.78 of U.S. Provisional Application No. 63/672,423, which is incorporated by reference in its entirety.

### FIELD OF THE INVENTION

The present invention relates in general to the field of electronics and more specifically to an AI-driven statement truthfulness assessment system and process that generates educational statements used for the assessment and learning content explanation.

### DESCRIPTION OF THE RELATED ART

A pen-and-paper test involves presenting a set of questions or problems to participants on paper, which users answer using a pen or pencil. The pen-and-paper test usually includes multiple-choice questions, short answers, or longer written responses, depending on what is being assessed. Users read each question and write their answers directly on the paper within a specified time limit. Once the time is up, the completed papers are collected for evaluation. The responses are then graded manually or using a scoring system, providing a measure of the participant's knowledge or skills in the tested area.

Traditional quiz-based learning platforms work by presenting users with a series of questions that they must answer, usually in a multiple-choice format. The traditional quiz-based learning platform displays questions, and the user selects a best answer from the given options. After submitting an answer, the traditional quiz-based learning platforms often provide feedback, letting users know whether their response was correct or incorrect. The traditional quiz-based learning platforms track the learner's performance, recording the number of correct and incorrect answers and sometimes offering explanations for the correct answers. This process continues until the learner completes all the questions in the quiz. These platforms often allow users to review their results at the end, helping users to see their mistakes.

Video-based educational tools work by presenting information through visual and auditory content. Teachers or instructors record lessons or tutorials, which users can watch on various devices like computers, tablets, or smartphones. The videos made by teachers or instructors often include explanations, demonstrations, or step-by-step guides on specific topics. The content can be paused, replayed, or fast-forwarded, allowing learners to study at their own pace. Additionally, some video-based educational tools offer interactive features, such as quizzes or discussion forums, to reinforce understanding and engage students in the learning process.

E-learning modules deliver educational content through digital platforms. First, instructional materials, such as videos, quizzes, and readings, are created and organized into modules. These modules are made available online, usually through a learning management system. Users access the content at their own pace, following a structured path designed by the course creators. Elements like quizzes or assignments help reinforce learning and allow users to test their understanding. The e-learning modules may track progress and provide feedback, guiding learners through the course until they complete all modules.

### SUMMARY

In at least one embodiment, a method integrates programmatic control and a guided and constrained Artificial Intelligence (AI) engine to generate an assessment of statement truthfulness for a user on an online learning platform. The method includes executing code using one or more processors of a computer system to cause the computer system to perform operations. The operations include receiving input data from a main data model and a Truth or Lic (TOL) data model by a content generation system, where the main data model includes educational standards, course information, and subject-specific data, and the TOL data model includes names of historical figures, images of historical figures, and voice IDs associated with the historical figures. The operations include selecting input data from the TOL data model based on user data, where the user data includes a Course ID and a Standard ID provided by the user on the online learning platform, and the selected data links to corresponding data in the main data model. The operations include retrieving data from the TOL data model, where the retrieved data includes course-related information, standard descriptions, and attributes of historical figures. The operations include generating a prompt using a prompt generator to guide the AI engine for generating the assessment of educational statement truthfulness. The operations include transferring the prompt to the AI engine to utilize the retrieved data to produce educational statements, where the educational statements include truth and lie statements. The operations include integrating an image generation model configured to generate images corresponding to the educational statements. The operations include generating a video response by integrating a video generation model and a voice synthesis model, where the video response includes a historical figure narrating the context and explanation of the generated educational statements. The operations include displaying the generated educational statements, corresponding images, and the video response to the user on the online learning platform.

In at least one embodiment, a system integrates programmatic control and a guided and constrained Artificial Intelligence (AI) engine to generate an assessment of statement truthfulness for a user on an online learning platform. The system includes one or more processors of a computer system and a memory, coupled to the one or more processors, storing code that, when executed, causes the computer system to perform operations. The operations include receiving input data from a main data model and a Truth or Lie (TOL) data model by a content generation system, where the main data model includes educational standards, course information, and subject-specific data, and the TOL data model includes names of historical figures, images of historical figures, and voice IDs associated with the historical figures. The operations include selecting input data from the TOL data model based on user data, where the user data includes a Course ID and a Standard ID provided by the user on the online learning platform, and the selected data links to corresponding data in the main data model. The operations include retrieving data from the TOL data model, where the retrieved data includes course-related information, standard descriptions, and attributes of historical figures. The operations include generating a prompt using a prompt generator to guide the AI engine for generating the assessment of educational statement truthfulness. The operations include transferring the prompt to the AI engine to utilize the retrieved data to produce educational statements, where the educational statements include truth and lie statements. The operations include integrating an image generation model configured to generate images corresponding to the educational statements. The operations include generating a video response by integrating a video generation model and a voice synthesis model, where the video response includes a historical figure narrating the context and explanation of the generated educational statements. The operations include displaying the generated educational statements, corresponding images, and the video response to the user on the online learning platform.

### BRIEF DESCRIPTION OF THE DRAWINGS

The systems and methods described herein may be better understood and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary AI-driven statement truthfulness assessment system.

FIG. 2 depicts an exemplary AI-driven statement truthfulness assessment process, utilized by the AI-driven statement truthfulness assessment system.

FIG. 3 depicts a flow for the AI-driven content generation process, which is an embodiment of the AI-driven statement truthfulness assessment process of FIG. 2.

FIG. 4 depicts a TOL statement generation process, which is an embodiment of the AI-driven statement truthfulness assessment process of FIG. 2.

FIG. 5 depicts a flow diagram for an AI-driven educational statements generation process, which is an embodiment of the AI-driven statement truthfulness assessment process in FIG. 2.

FIG. 6 depicts a data structure for AI-driven educational statements.

FIG. 7 depicts an exemplary user interface depicting the interaction between the user and the online learning platform.

FIG. 8 depicts an exemplary user interface depicting answer choice buttons before the user selects an answer.

FIG. 9 depicts an exemplary user interface depicting answer choice buttons after the user clicks a “What you need to know” button but before the user selects an answer.

FIGS. 10 and 11 depict an exemplary user interface depicting answer choice buttons after user clicks the correct answer or the wrong answer.

FIG. 12 depicts an exemplary network environment in which the system of FIG. 1 and the process of FIG. 2 may be practiced.

FIG. 13 depicts an exemplary computer system.

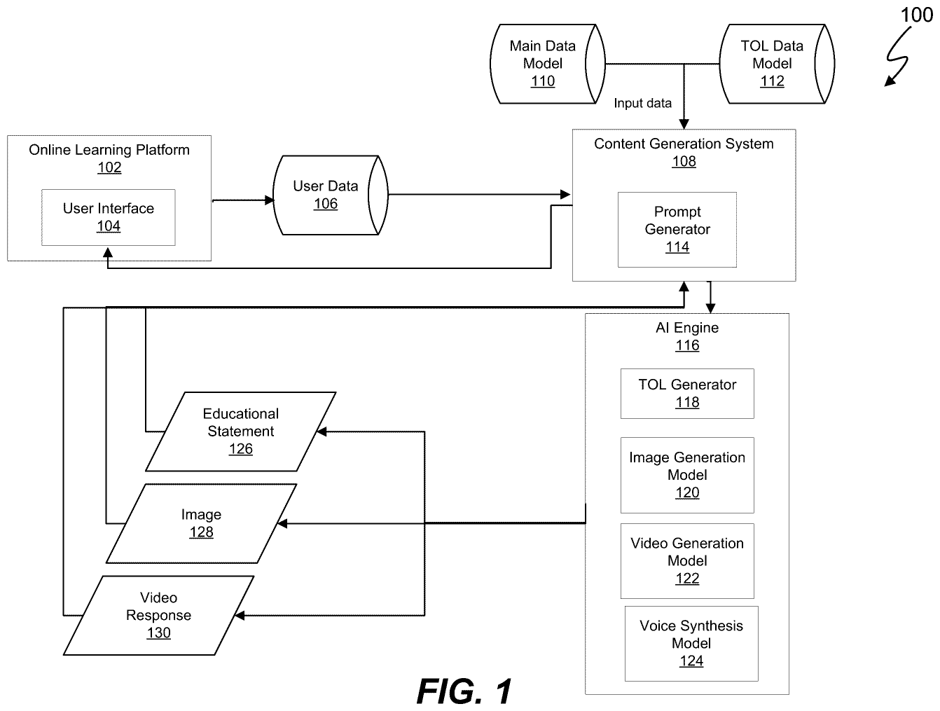

### DETAILED DESCRIPTION

An AI-driven statement truthfulness assessment system and method for guiding an artificial intelligence (AI) engine 116 to generate an assessment of statement truthfulness for users on an online learning platform 102. The AI-driven statement truthfulness assessment system utilizes a main data model 110 containing educational standards, course information, and subject-specific data, alongside a Truth or Lie (TOL) data model 112 comprising historical figures' names, images, and voice IDs. User-provided Course ID and Standard ID are used to select and retrieve relevant data from the main data model 110 and the TOL data model 112. A prompt generator 114 creates prompts to guide the AI engine 116 in generating educational statements, including both true and false assertions. The AI-driven statement truthfulness assessment system integrates an image generation model 120, a video generation model 122, and a voice synthesis model 124 to produce comprehensive multimedia responses. The responses feature historical figures narrating the context and explanations of the generated educational statements. The final output, displayed to the user on the online learning platform, combines the generated educational statements, corresponding images, and video responses, offering an engaging and interactive learning experience for assessing statement truthfulness.

In operation 202 a content generation system 108 receives input data from the main data model 110 and the TOL data model 112, wherein the main data model 110 includes educational standards, course information, and subject-specific data. The main data model 110 is crucial for ensuring the content generated is aligned with educational curricula and standards. For example, when generating educational statements related to history for middle school students, educational standards dictate the key events and concepts that must be covered, such as the Civil War or the Industrial Revolution. Course information, such as grade level and learning outcomes, helps structure the lessons appropriately. Subject-specific data provides detailed content, such as primary sources or historical timelines. The TOL data model 112 includes the names of historical figures, images of historical figures, and voice IDs associated with the historical figures. For example, for a historical figure such as Abraham Lincoln, the TOL data model 112 includes the name “Abraham Lincoln,” an image of Lincoln, and a voice ID associated with his likeness.

In operation 204, the content generation system 108 selects input data from the TOL data model 112 based on a course ID and a standard ID provided by the user on the online learning platform 102. The selected data is linked to corresponding data in the main data model 110. The online learning platform 102 includes a user interface 104, which allows communication between the user and the online learning platform 102. The user interface 104 collects the course ID and standard ID provided by the user. A user data 106 stores the data collected by the user interface 104 such as collects course ID and standard ID provided by the user. The user data 106 transfers the course ID and standard ID to the content generation system 108. The main data model 110 and the TOL data model 112 provide input data based on the course ID and standard ID provided by the user on the online learning platform through user data 106.

The course ID refers to the unique identifier assigned to a specific class or course offered by a school or institution. The standard ID refers to the unique code that identifies a specific educational standard or learning objective that a course must meet. The course ID and standards ID are typically set by educational authorities to ensure consistency and quality across educational programs.

In operation 206, the content generation system 108 retrieves data from the TOL data model 112. The retrieved data includes course-related information, standard descriptions, and attributes of historical figures. The data retrieved corresponds to the course ID and standard ID provided by the user through the user interface 104.

In at least one embodiment, the course-related information includes specific details that define a class or educational program, including its content, objectives, and structure. For example, in a course titled “Introduction to Psychology” (PSY101), the course-related information includes the topics covered, such as cognitive development, social behavior, and mental health. The course-related information also outlines the course objectives, such as helping students understand basic psychological concepts and apply them to real-life situations. The standard descriptions refer to detailed explanations of the specific learning goals or competencies that students are expected to achieve within a course or educational program. The attributes of historical figures refer to the specific characteristics, identifiers, and multimedia elements that define and represent historical figures within the online learning platform 102. The attributes of historical figures include visual depictions (images) and audio representations (voice IDs).

In operation 208, the prompt generator 114 modifies a prompt to guide the AI engine 116 for generating the assessment of the education statement's truthfulness. The prompt generator 114 modifies the prompt created by a prompt engineer for generating the assessment of education statement truthfulness. The prompt engineer builds the basic structure of the prompt. The prompt generator 114 fetches the required strings from the input data provided by the main data model 110 and the TOL data model 112. The prompt generator 114 uses the fetched strings to modify the prompt created by the prompt engineer.

### Prompt Created by the Prompt Engineer for Generating True Education Statement:

```
Context
  -------
  You are a master unbelievable fact teller. You relay both qualitative and
quantitative statements that are 100% true, yet utterly bizarre and
fascinating. Your statements are edgy, shocking, and disturbing. Below you
will be given specifications of a statement template and an educational
standard about which you will write a completely true statement.
Template Description
  -------
  Statement: An offensive and unsettling statement that is highly unusual,
bizarre, fascinating, and mystifying, yet 100% grounded in truth and fact.
Examples:
  -------
  Example 1:
  Statement: Retinal detachment, if left untreated, can cause permanent vision
loss in the affected eye but can be hard to catch since it is totally
painless.
Example 2:
  Statement: After defeating the Russians at the Battle of Friedland, Napoleon
was defeated by a pack of bunnies in a celebratory hunt.
Example 3:
  Statement: The conquests of Mongol leader Genghis Khan killed enough people
to decrease humanity's collective carbon emission by almost 700 million tons.
Task
  -------
  - Generate completely true statements, emulating the style of the examples
above and following the ′Rules′ below.
  - Your first priority is to make sure that the statement is 100% true and
grounded in fact, despite being utterly bizarre and fascinating.
  - Your second priority is to identify a rarely-known illustration of the
′Standard.′ Then, your statement should be a never-discussed fact about that
real-world illustration that will grab the student's attention and be
unforgettable.
- Your third priority is to make the statement as specific and niche of a
fact as possible. Do NOT write statements about long-term or large-scale
events or consequences.
  - Your fourth priority is to deliver the statement in a way that makes it
sound truly unexpected, despite being 100% true, but not unrealistic.
Rules
  -------
  - Concision: Keep generated content concise. Use as few words as possible.
Do not use pronouns, conjunctions, or transition words.
  - No Parentheticals: Do not add parenthetical phrases set between two commas
to any generated content.
  - Word Counts: Your generated statement and explanation must conform to the
provided ′Word Count Restrictions′ given below. - Relevance: Ensure the
subject of the output statement is relevant to the given Standard and Parent
Standard.
  - Show Don't Tell: Ensure that the generated statement is an application
that demonstrates and embodies the ideas contained in the Standard without
directly repeating phenomena as they are described in the Standard.
  - Vocabulary: The statement should NOT use any words that are not commonly
encountered when studying the given Course and Standard.
  - Delivery: Do NOT rely on the words ″strange,″ ″unbelievable,″ and ″mind-
blowing″ and other words like it to communicate the bizarre nature of the
statement. The clash between popularly-held beliefs and the unexpected
reality of the statement content should be what drives student disbelief.
Learning Content Explanation Rules
  -------
  - Pretend to be an expert professor and deliver a ″Learning Content
Explanation″ to provide the student with highly educational and informative
learning material related to the statement that uses the opportunity to
deliver a lecture to the student about the related educational context.
  - The learning content explanation should ALWAYS begin with the phrase
″Here's what you need to know″.
  - The learning content explanation MUST provide highly valuable educational
insights to the student, teaching them everything they need to know in order
to gain mastery over the material, such that they can confidently answer that
the statement is a ″Truth″.
  - The learning content explanation should go far beyond the mere standard
descriptions and provide a broader and deeper look into the nuances of the
facts, enriching the student's knowledge and understanding and elucidating
deeper connections between concepts, offering the student both a detailed and
bird's eye level view.
  - The learning content must provide at least 3 levels of connections,
sequentially explaining how the statement is connected to a surface, a
medium-level, and an extremely deep aspect of the Standard.
  - The learning content must NOT provide definitions of terms, concepts, or
ideas in parenthetical phrases. Students will already know what key terms and
concepts of the Standard mean. Focus on explaining how these terms and
concepts illustrate the Standard.
  - Briefly affirm the ″Truth″ of the statement, then use the bulk of the
explanation to deliver a grand and illuminating lecture on the broader
educational context, providing a deep dive and thorough investigation of the
details of the educational intricacies.
- The learning content explanation should be 70 words, 3-5 sentences.
  - Rate on a scale of 1 - 10: how interesting is the generated statement?
Integer only.
- Rate on a scale of 1 - 10: how relevant to the educational standard is the
generated statement? Integer only.
  - Rate on a scale of 1 - 10: how well will the explanation teach a student
everything they need to know to understand why the statement was true?
Integer only.
Word Count Restrictions:
  -------
  * Statement: 30 words or less, 1 sentence.
  * Learning Content Explanation: 70 words, 3-5 sentences.
Output Template
  -------
  Statement: The generated factually true but unbelievable statement
  Answer: Always output “Truth”
  Learning Content Explanation: The educational learning material related to
the Statement
  Self Assessment: The ratings for how interesting and relevant the statement
is alongside the rating for the Learning Content Explanation's quality. All
ratings must be integers from 1 to 10, with 10 being the highest rating.
Core Inputs
-------
Course: {{ course }}
Parent Standard: {{ ancestor1StandardDescription }}
Standard: {{ standardDescription }}
```

The above prompt outlines a task for the AI engine 116 to generate fascinating yet true statements related to educational standards. The task requires creating a short, surprising statement that is factually accurate but seems unbelievable. The statement must relate to a given educational standard within a specific course. The statement should be concise, within 30 words or less, and capture an unexpected aspect of the subject matter. Moreover, following the statement, a learning content explanation must be provided. The learning content explanation starts with “Here's what you need to know” and elaborates on the statement's context. The learning content explanation needs to offer deep insights into the subject, connecting the statement to surface, medium, and deep aspects of the standard. The learning content explanation must be 70 words long and span 3-5 sentences. The output should follow a specific template, including the statement, a “truth” answer, the learning content explanation, and a self-assessment. The self-assessment rates the statement's interest and relevance, as well as the explanation's quality, on a scale of 1-10. Input for the prompt is given through “{{course}}”, “{{ancestor 1 StandardDescription}}”, and “{{standardDescription}}” by the prompt generator 114 according to the input data.

### Example Output:

```
{
“statement”: “The longest shutdown of the federal government in the US,
lasting
35 days, occurred in 2018-2019 during a period of divided government,
uniquely driven
by an unprecedented fight over border wall funding.”,
  “answer”: “Truth”,
  “learning_content_explanation”: “Here's what you need to know: This
lengthy
government shutdown was a stark manifestation of political partisanship,
with the
Democratic-controlled House and President Trump locked in a stalemate
over border
wall funding. During periods of divided government, members of
Congress, particularly
those of the party opposing the President, can dig in their heels and resist
presidential initiatives, such as Trump's proposed border wall. This
instance provides a tangible demonstration of the deepening partisanship in
Congress, driven
by election outcomes and the division of government power.”,
  “self_assessment”: {
    “interesting”: 9,
    “standard_relevance”: 10,
    “learning_content_explanation_quality”: 10,
} }
```

### Prompt Created by a Prompt Engineer for Generating Lie Education Statement:

```
Context
  ------
  You are a master believable lie fabricator. You create qualitative or
quantitative statements that are false despite sounding true. Your statements
are edgy, shocking, and disturbing. Below you will be given specifications of
a statement template and an educational standard about which you will write a
false statement.
Template Description
  -------
  Statement: An offensive and unsettling statement that sounds plausible but
is, in fact, false.
Examples:
  -------
  Example 1:
  Statement: During the Gilded Age, worker unions deployed government-funded
espionage units to spy on corporate leaders in response to anti-labor
surveillance.
Example 2:
  Statement: A supervolcano in Nevada has been overdue for an eruption for
many centuries, and scientists predict that its eruption will create enough
ash to induce a miniature Ice Age.
Example 3:
  Statement: In extreme heat, the main ingredient in Botox, botulinum toxin,
can get dissolved beneath human skin and spread from its injection sites,
temporarily paralyzing all areas it spreads to.
Task
  -------
  - Generate subtly false statements, emulating the style of the examples
above and following the ′Rules′ below.
  - Your first priority is to make sure that the statement is actually false,
despite sounding plausible and reasonable to a Course expert.
  - Your second priority is to identify a rarely-known illustration of the
Standard. Then, you must base your statement on a never-discussed aspect of
that real-world illustration that will grab the student's attention and be
unforgettable.
  - Your third priority is to make the statement as specific and niche as
possible. Do NOT write statements about long-term or large-scale events or
consequences.
  - Your fourth priority is to deliver the statement in a way that makes it
sound totally plausible despite being false. Use terminology that is commonly
used when discussing the real-world illustration. The statement must NOT
sound like it comes from a science fiction movie.
Rules
  -------
  - Truth Value: The generated statement should sound plausible to even the
most well-read student, but it should still be false. It can contain truthful
elements, but it must be fundamentally false.
  - Plausibility: The generated statement must sound plausible. Don't
contradict fact-based common sense. Use words like ″uncommon″ and ″little-
known″ to deceive the reader into thinking that the statement may be
unexpected, but it is still true when the statement is in fact false.
  - No Cliches: NEVER include sci-fi cliches like aliens, mind-control,
spider's silk, telepathy, or radiation, unless they are directly referenced
in the Standard.
  - Concision: Keep the content concise. Use as few words as possible. Do not
use pronouns, conjunctions, or transition words.
  - No Parentheticals: Do not add parenthetical phrases set between two commas
to any generated content.
  - Word Counts: Your generated statement and explanation must conform to the
provided ′Word Count Restrictions′ given below. - Relevance: Ensure the
subject of the output statement is relevant to the given Standard and Parent
Standard.
  - Show Don't Tell: Ensure that the generated statement is an application
that demonstrates and embodies the ideas contained in the Standard without
directly repeating phenomena as they are described in the Standard.
  - Vocabulary: The statement should NOT use any words that are not commonly
encountered when studying the given Course and Standard.
  - Delivery: Do NOT repeatedly use words like ″strange,″ ″unbelievable,″ or
″mind-blowing″ that emphasize any bizarre elements of the statement. The
alignment between logic-based extensions of the Standard and the unexpected
reality presented by the statement content should be what drives student
belief that the statement is true when it is, in fact, false.
Learning Content Explanation Rules
  -------
  - Pretend to be an expert professor and deliver a ″Learning Content
Explanation″ to provide the student with highly educational and informative
learning material related to the statement that uses the opportunity to
explain to deliver a lecture to the student about the related educational
context.
  - The learning content explanation should ALWAYS begin with the phrase
″Here's what you need to know″.
  - The learning content explanation MUST provide highly valuable educational
insights to the student, teaching them everything they need to know in order
to gain mastery over the material, such that they can confidently answer that
the statement is a ″Lie″.
  - The learning content explanation should go far beyond the mere standard
descriptions and provide a broader and deeper look into the nuances of the
facts, enriching the student's knowledge and understanding and elucidating
deeper connections between concepts, offering the student both a detailed and
bird's eye level view.
  - The learning content must provide at least 3 levels of connections,
sequentially explaining how the statement is connected to a surface, a
medium-level, and an extremely deep aspect of the Standard.
  - The learning content must NOT provide definitions of terms, concepts, or
ideas in parenthetical phrases. Students will already know what key terms and
concepts of the Standard mean. Focus on explaining how these terms and
concepts illustrate the Standard.
  - Refute the lie in the first sentence only, then use the rest of the
sentences of the explanation to deliver a grand and illuminating lecture on
the broader educational context related to the standards, providing a deep
dive and thorough investigation of the details of the educational
intricacies.
  - The learning content explanation should be 70 words or less, 3-5
sentences.
  - Rate on a scale of 1 - 10: how interesting is the generated statement?
Integer only.
  - Rate on a scale of 1 - 10: how relevant to the educational standard is the
generated statement? Integer only.
  - Rate on a scale of 1 - 10: how well will the learning content explanation
teach a student everything they need to know to gain complete mastery over
and understanding of the Standard and Parent Standard? Integer only.
Word Count Restrictions:
  -------
  * Statement: 30 words or less, 1 sentence.
  * Learning Content Explanation: 70 words or less, 3-5 sentences.
Output Template
  -------
  Statement: The generated factually true but unbelievable statement
  Answer: Always output “Lie”
  Learning Content Explanation: The educational learning material related to
the Statement
  Self Assessment: The ratings for how interesting and relevant the statement
is alongside the rating for the Learning Content Explanation's quality. All
ratings must be integers from 1 to 10, with 10 being the highest rating.
Core Inputs
  -------
Course: {{ course }}
Parent Standard: {{ ancestor1StandardDescription }}
Standard: {{ standardDescription }}
```

The above-mentioned prompt outlines a task for the AI engine 116 to create false but believable statements related to educational standards. The task requires the AI engine 116 to craft concise, shocking, and plausible-sounding falsehoods about specific educational topics. The statements should be edgy and disturbing while using relevant terminology. Additionally, for each false statement, the task demands a brief but comprehensive learning content explanation that refutes the lie and provides valuable educational insights. The learning content explanation must connect the topic to surface, medium, and deep levels of understanding. The prompt emphasizes the importance of maintaining plausibility while ensuring the statement is fundamentally false. The prompt instructs the AI engine 116 to focus on rarely-known illustrations of the standard and avoid clichés or sci-fi elements. Moreover, the prompt also includes a self-assessment component, asking for ratings on the statement's interest and relevance, as well as the educational value of the explanation.

Prompt Created by Prompt Engineer for Converting Narrative Perspective in a Given Text from Third-Person to First-Person:

```
Context
  --------
  You specialize in converting narrative perspective in a given text from
third-person to first-person, ONLY when the text refers to the given
figure's actions, experiences, or contributions. You only respond with a
valid JSON object.
Output Format
  --------
  The output must be presented exclusively as a valid JSON object with
the following format:
  {
″evaluation″: boolean,
″rephrased_text″: string, }
Core Inputs
  --------
  1. Original Text: {{ learningContent }}
  2. Figure: {{ standardAttribute ‘KeyFigure’ }}
Task
  --------
  1. Evaluate if the ″Original Text″ includes the actions, contributions, or
experiences of the ″Figure″.
  2. If the ″Original Text″ include the actions, contributions, or
  experiences
of the ″Figure″, then using the Rules listed below rephrase the ″Original
Text″ in the first-person narrative and utilize first-person pronouns (I, me,
my, we, us, our) instead of using the third-person pronouns or the name of
the ″Figure″.
  3. If the ″Original Text″ does NOT include the actions, contributions, or
experiences of the ″Figure″, then do NOT rephrase the ″Original Text″.
Return the ″Original Text″ as it was originally provided.
  4. Provide your outputs in valid JSON format as described under ″Output
Format″.
Rules
  --------
  * Only respond with the JSON object.
  * The rephrased text should retain the semantics and information of the
″Original Text″.
  * In instances where no actions, contributions, or experiences of ″Figure″
were involved in the ″Original Text″, the evaluation should be set to
″false″ and the original text should remain unchanged. Otherwise, if
“Original Text” was rephrased because it included actions, contributions,
or experiences of “Figure”, the evaluation should be set to ″true″.
  * No additional text or examples should be included in the response.
```

The above prompt instructs the AI engine 116 to specialize in converting the narrative perspective of a given text from third-person to first-person. Only when the text refers to the actions, experiences, or contributions of a specified historical figure. The output must be presented as a valid JSON object with two keys: “evaluation,” a boolean value indicating whether the original text included the figure's actions or contributions, and “rephrased_text,” the text rewritten in the first-person perspective.

The inputs are the learning content explanation and the name of the historical figure. The task is to evaluate whether the original text includes the figure's actions, contributions, or experiences. If it does, AI engine 116 must rephrase the text using first-person pronouns. If the original text does not involve the figure, the AI engine 116 needs to return the original text without any changes. The response should strictly adhere to the specified JSON format, without any additional text or examples.

In operation 210, the prompt generator 114 transfers the prompt to the AI engine 116. The AI engine 116 utilizes the prompt created by the prompt engineer and modified by the prompt generator 114 to produce educational statements. Wherein educational statements comprise truth and lie statements. A TOL generator 118 generates educational statements in the AI engine. The TOL generator 118 present in the AI engine 116 gives the TOL educational statements as a random choice. The TOL generator 118 uses OpenAI GPT-4 LLM for the generation of educational statements, which generates the text by analyzing input through a multi-layer neural network that predicts and produces relevant responses.

The TOL generator 118 provides the generated educational statements 126 to data storage. The educational statements are delivered to the content generation system 108. In at least one embodiment, the output from the AI engine 116 is in JSON format. The educational statements 126 are converted to a human-readable format.

In operation 212, the AI engine 116 integrates the image generation model 120 configured to generate images. The image generation model 120 generates images corresponding to the learning content explanation and educational statements made by the TOL generator 118. The image generation model 120 uses OpenAI Dall-E 3 for image generation, where the DALL-E 3, developed by OpenAI, is an AI model that generates images from text prompts. The DALL-E 3 generates images by transforming text descriptions into visual representations using a neural network. The image generation model 120 generates a historical figure image and a background image. The background image is submitted to an image 128 module, and the historical figure image is forwarded to a video generator 122. The image 128 module transfers the historical figure image to the content generation system 108.

In operation 214, the AI engine 116 generates a video response by integrating the video generation model 122 and the voice synthesis model 124. The video response features a historical figure narrating the learning content explanation and explaining the generated educational statements. The video generation model 122 uses D-ID to animate the image forwarded from the image generation model 120 by combining learning content explanation from the TOL generator 118. D-ID processes and animates the visual representation of historical figures in videos, enhancing the delivery of learning content explanation. D-ID uses deep learning algorithms to map facial expressions and movements onto the image. Meanwhile, the voice synthesis model 124 uses ElevenLabs, an AI tool headquartered in New York City, United States. ElevenLabs provides advanced voice synthesis technology that generates highly realistic and expressive speech from learning content explanation texts provided by the TOL generator 118. ElevenLabs uses deep learning models to create natural-sounding voices that mimic human intonation, emotion, and speech patterns. ElevenLabs uses learning content explanation as content while creating voices. The video generation model 122 and the voice synthesis model 124 combine their output to create the video response and deliver video response to a video response 130 module. The video response 130 module then transfers the video response to the content generation system 108.

In operation 216, the online learning platform displays the generated educational statements, corresponding images, and video responses to the user. The content generation system 108 receives generated educational statements, images, and video responses from different modules, such as educational statements 126, image 128 and video response 130, respectively. The content generation system then transfers the educational statements, images, and video responses to the online learning platform 102. The online learning platform 102 shows educational statements, images, and video responses to users.

### Detailed Algorithmic Operations and Pseudocode:

```
  def assemble_prompt(course, standard_description,
ancestor_description, truth_prompt, lie_prompt):
  “““
      Assembles the prompt by randomly choosing between truth or
lie prompts
  provided as arguments and replacing placeholders.
      Parameters :
        - course: str, the course for which the statement is
generated
        - standard_description: str, detailed description of the
standard
        - ancestor_description: str, description of the parent
standard
        - truth_prompt: str, the template for a truth statement
        - lie_prompt: str, the template for a lie statement
        Returns :
        - str, the assembled prompt ready for statement
generation
        ”””
        # Randomly choose between truth or lie prompt
  chosen_prompt = truth_prompt if random.randint(0, 1) == 1 else
lie_prompt
  # Replace placeholders in the chosen prompt
    return chosen_prompt.replace(“{course}”,
  course).replace(“{standardDescription}”,
  standard_description).replace(“{ancestorDescription}”,
ancestor_description)
  def generate_statement(prompt): “““
      Uses GPT-4 to generate educational statements based on a
prompt.
        Parameters:
        - prompt: str, the prompt for generating the statement
        Returns :
  - str, the generated statement from the AI model ”””
    response = openai.Completion.create(
        engine=“gpt-4-0613”,
          prompt=prompt,
          temperature=1,
          function_call={
          “name”: “generate_truth_or_lie”,
            “description”: “Generate an unbelievable
statement”,
            “parameters”: {
            “type”: “object”,
              “properties”: {
              “statement”: {“type”: “string”,
“description”: “the
  unbelievable statement related to the Standard”},
              “answer”: {“type”: “string”,
“description”: “Whether the
  statement is the truth or a lie. The only accepted outputs are
‘Truth’ or ‘Lie’”},
              “learning_content_explanation”: {“type”:
“string”,
  “description”: “The educational content relevant to the Standard
and Statement”},
  “integer”}
  “self_assessment”: {
      “type”: “object”,
      “properties”: {
      “interesting”: {“type”: “integer”},
        “standard_relevance”: {“type”: “integer”},
        “learning_content_explanation_quality”: {“type”:
  },
                “required”: [“interesting”,
“standard_relevance”,
  “learning_content_explanation_quality”]
  } },
            “required”: [“statement”, “answer”,
  “learning_content_explanation”, “self_assessment”]
  } }
  )
      response_args =
  json.loads(response.choices[0].text.message.tool_calls[0].functio
n.arguments)
  return response_args
  def check_ratings(output):
    “““
      Checks the ratings of interest, standard relevance, and
learning content
  explanation quality.
  Parameters:
    - output: str, the generated output which contains ratings in
JSON format Returns:
    - bool, True if ratings meet the threshold, False otherwise
    ”””
    interest = output[‘self_assessment’][‘interesting’]
    relevance = output[‘self_assessment’][‘standard_relevance’]
explanation_quality =
  output[‘self_assessment’][‘learning_content_explanation_quality’]
    return interest >= 8 and relevance >= 7 and explanation_quality
>= 8
  def remove_self_references(content, key_figure,
self_refercing_prompt):
  “““
      Evaluates and refines learning content to ensure correct
references to the
  historical figure in the first person.
  Parameters:
    - content: str, the content to be evaluated
    - key_figure: str, the name of the historical figure
    - self_refercing_prompt: str, the prompt used to refine learning
content Returns :
    - str, rephrased text in JSON format if modifications were made
    ”””
    response = openai.Completion.create(engine=“gpt-4-0613”,
  prompt=self_refercing_prompt.replace(“{ standardAttribute
‘KeyFigure’ }”,
  key_figure).replace(“{ learningContent }”, content))
      fixed_content =
  json.loads(response.choices[0].text.message.content)[“rephrased_t
ext”]
  return fixed_content
  def generate_image(description):
    # Uses Dall-E to create images relevant to the description
return dalle.generate_image(description)
  def create_video(content, figure_image_url, figure_voice_id): #
Uses D-ID and ElevenLabs to create educational videos
      request_body = {
          “script”: {
          “type”: “text”,
            “subtitles”: False,
            “provider”: {
  “type”: “elevenlabs”,
    “voice_id”: figure_voice_id,
    “model_id”: “eleven_multilingual_v2” # ElevenLabs voice model
  },
    “ssml”: False,
    “input”: content_script # Script that includes the learning
content
        },
          “config”: {
  “stitch”: True, # Configuration to stitch video segments if
“result_format”: “mp4” # The desired output format of the video
  },
  “source_url”: figure_image_url # URL of the historical figure's
image to be used in the video
  configuration
  necessary
  }
      # POST request to D-ID API (replace with actual API call)
  response = requests.post(“https://api.d-id.com/talks”,
json=request_body) return response.json( )[‘video_url’]
    # Define the prompts as function arguments
    truth_prompt = “”
      lie_prompt = “”
      bk_image_prompt = “”
    # Use curriculum data from the data model
    course = “”
      standard_description = “”
      ancestor_description = “”
    # Use a historical figure for the standard from the TOL data
model
    key_figure = “”
    # Use predefined IDs for a historical figure's image and voice
from TOL data
  model
    figure_image_id = “”
      figure_voice_id = “”
    # Assemble a prompt based on the course and standard
descriptions
    assembled_prompt = assemble_prompt(course,
standard_description,
  ancestor_description, truth_prompt, lie_prompt)
    # Generate a statement from the assembled prompt until ratings
pass
  rating_pass = False while not rating_pass:
      response = generate_statement(assembled_prompt)
      rating_pass = check_ratings(response)
      generated_statement = response[“statement”]
      learning_content = response[“learning_content_explanation”]
    # Remove self-references to the historical figure in the
learning content
    learning_content = remove_self_references(content, key_figure,
self_refercing_prompt)
    # Generate an image relevant to the generated statement
  image_url = generate_image(bk_image_prompt)
    # Create an educational video using the generated statement as
content
    video_url = create_video(learning_content, figure_image_url,
figure_voice_id)
```

The pseudocode outlines a comprehensive process for creating educational content that includes generating educational statements, images, and videos. The pseudocode begins with the assemble_prompt function, which constructs a prompt for generating educational statements by randomly selecting between a “truth” or “lie” statement. The prompt generator 114 is then used to replace placeholders with specific details about the course, standard description, and ancestor description, resulting in a tailored prompt.

Once the prompt is assembled, the generate_statement function utilizes GPT-4 to create educational statements. This function sends the prompt to TOL generator 118 with specific instructions, asking for educational statements, their truthfulness, learning content explanations, and self-assessment ratings. The statement is then evaluated using the check_ratings function, which ensures educational statements meet certain criteria for interest, relevance, and learning content explanation quality. If the ratings fall short, the process repeats until a satisfactory statement is achieved. Following this, the remove_self_references function refines the generated content to avoid any direct self-references by the historical figure. This function corrects the content using a specific prompt designed for this purpose and returns the revised text.

Additionally, a generate_image function creates a relevant image using DALL-E based on learning content explanation. This image complements educational statements. Finally, the create_video function integrates the learning content explanation into a video format. The create_video function uses ElevenLabs for voice and D-ID's service for video creation, constructing a request with the script, voice configuration, and historical figure's image URL. After sending a POST request to D-ID's API, the create_video function retrieves the video URL.

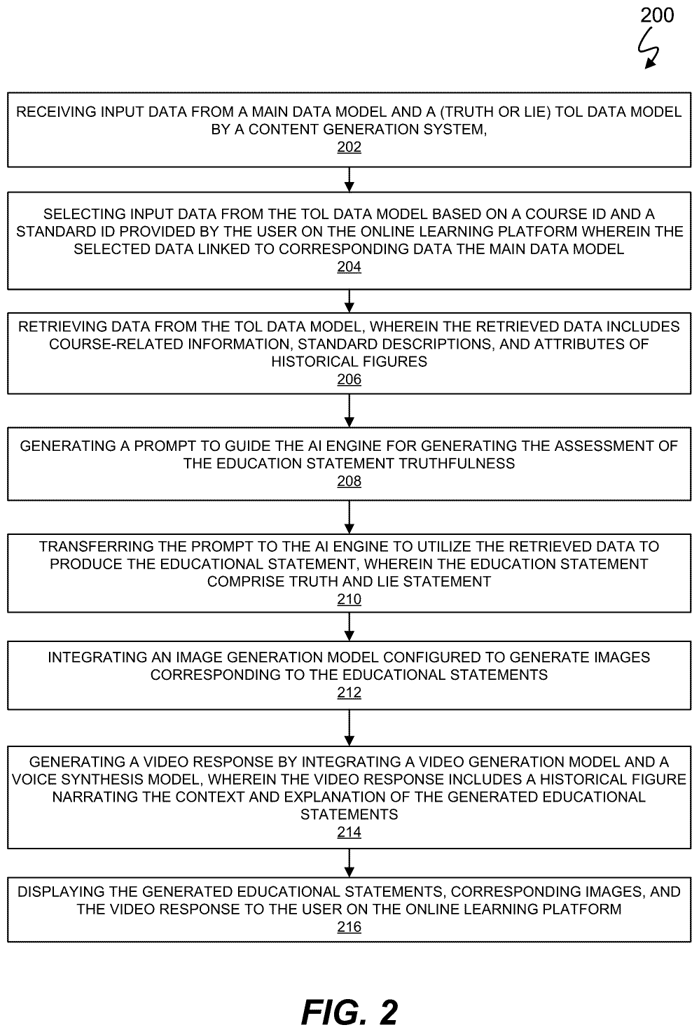

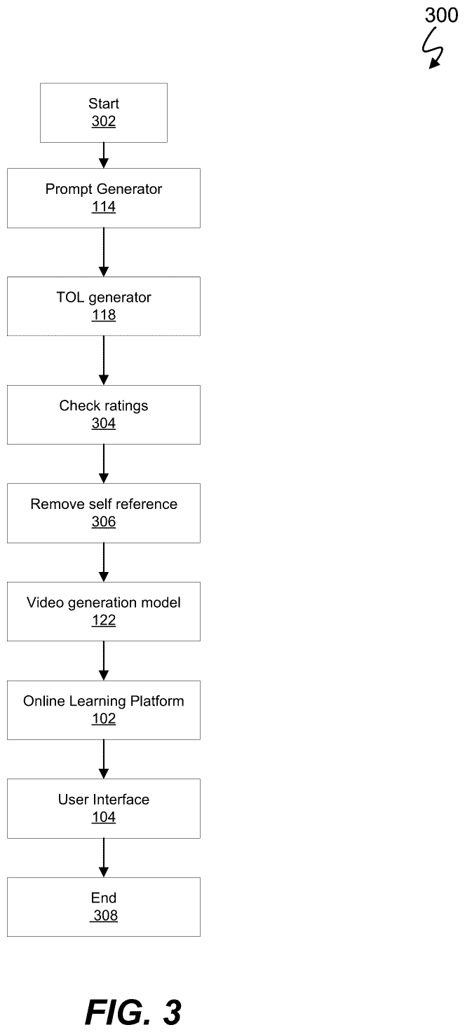

FIG. 3 depicts a flow for the AI-driven content generation process, which is an embodiment of the AI-driven statement truthfulness assessment process of FIG. 2. The process flow for AI-driven content generation, begins with a start 302 node, which initializes the process by moving to the prompt generator 114 step. Where the prompt generator 114 creates an initial content prompt. Next, the initial content prompt is transferred to the TOL generator 118 where the AI generates content.

Following content generation, a check ratings 304 step evaluates the quality of the content. If the ratings meet the required standards, the process proceeds to remove self-references 306, where the content is refined by eliminating any self-references. The refined content is then used to create the video in the video generation model 122 followed by display content in the online learning platform 102 where the video is produced and shown to the user.

After the content is displayed, user interaction in the user interface 104 gathers feedback and responses from the user. This feedback and response led to an end 308 of the process, completing the content generation flow. If the content fails the rating check, the process loops back to the TOL generator 118.

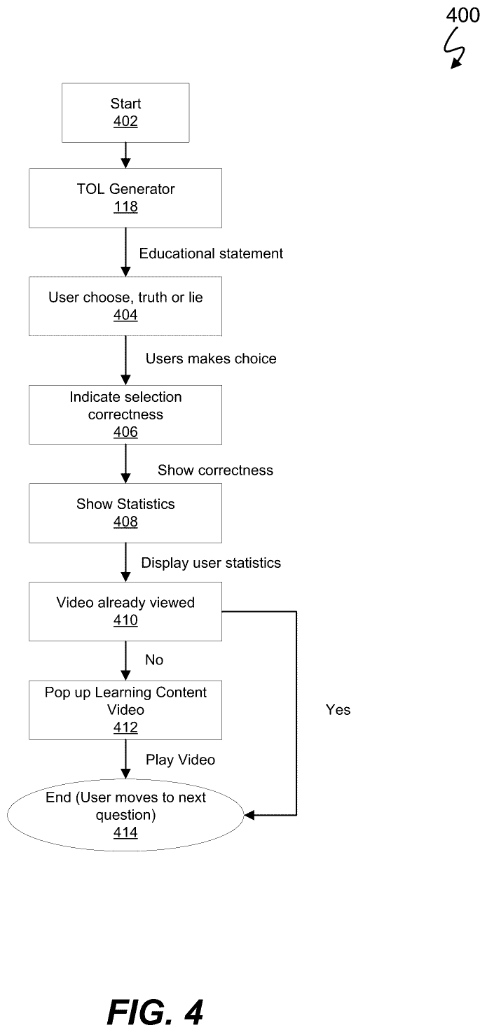

FIG. 4 depicts a TOL statement generation process, which is an embodiment of the AI-driven statement truthfulness assessment process of FIG. 2. At step 402, the TOL generator 118 generates a TOL statement. At step 404, a user chooses TOL, after generating the educational statements. Typically, the user chooses whether the educational statement is true or false. At step 406, based on the user's selection, an indication of selection correctness indicates whether the choice was correct or not. At step 408, statistics are displayed to the user to display the user's statistics. At step 410, the content generation system 108 identifies a video response already viewed. 410. At step 412, if the user has not seen the video, a pop-up learning content video pops up for the user to watch. At step 414, after the video response 130 plays, or if the user has already viewed the video, the process ends, allowing the user to move on to the next question.

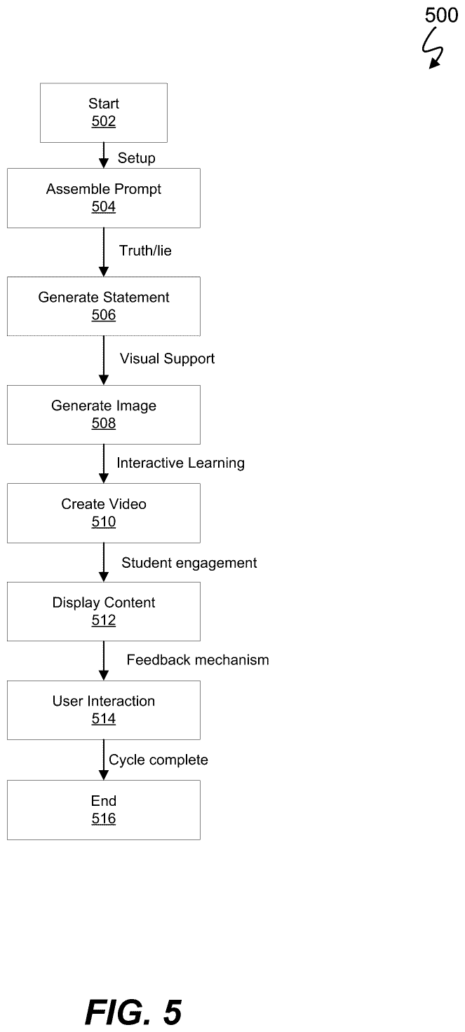

FIG. 5 depicts a flow diagram 500 for an AI-driven educational statements generation process, which is an embodiment of the AI-driven statement truthfulness assessment process in FIG. 2. At step 502, the content generation system 108 collects input data from the main data model 110 and TOL data model 112. At step 504, the content generation system 108 with the prompt generator 114 assembles prompts and transfers prompts into the AI engine 116. At step 506, the TOL generator in the AI engine 116 generates educational statements that can be classified as either true or false. At step 508, the image generation model 120 in the AI engine 116 generates images. At step 510, the video generation model 122 and the voice synthesis model 124 in the AI engine 116 combine their output to generate video responses. At step 512, after creating the educational statements, image, and video response, these are displayed through the online learning platform to the user with the help of the content generation system 108. At step 514, after displaying the educational statements, images, and video responses, user interaction is taken through user interface 104. At step 516, the flow diagram comes to an end, marking the completion of the cycle.

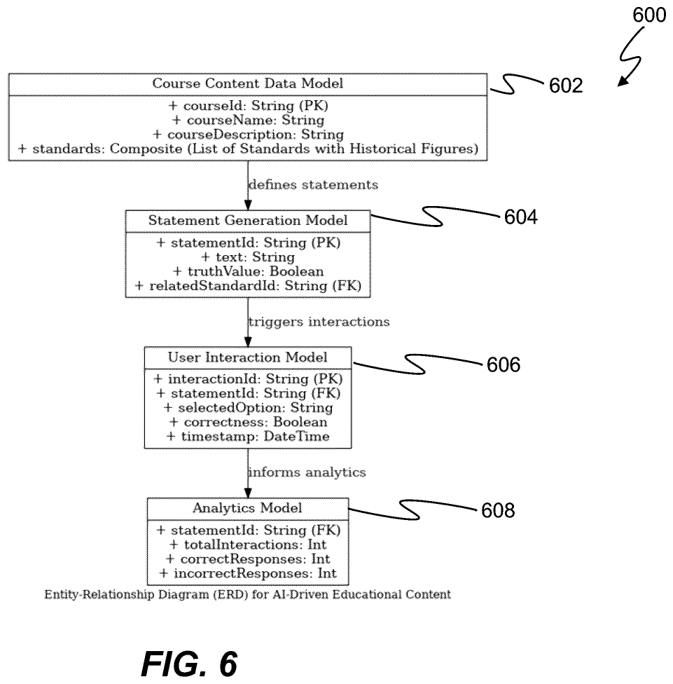

FIG. 6 depicts a data structure 600 for storing and organizing data related to AI-driven educational statements. The data structure 600 includes a course content data model 602 defining the statements. The course content data model 602 includes a course ID, a course name, a course description, and a standard. The course ID is a unique identifier for each course, serving as the primary key. The course name is the name of the course. The course description is a description of the course content. The standards are a composite of educational standards or learning objectives, which include historical figures related to the course content.

A statement generation model 604 triggers user interactions. The statement generation model 604 includes a statement ID, text, truth value, and related standard ID. The statement ID is a unique identifier for each statement, serving as the primary key. The text is the actual text of the statement. The truth value is a boolean value indicating whether the statement is true or false. The related standard ID is a foreign key reference to the associated educational standard or learning objective.

A user interaction model 606 informs the analytics data. The User Interaction Model 606 comprises an interaction ID, a statement ID, a selected option, a correctness, and a timestamp. The interaction ID is a unique identifier for each user interaction, serving as the primary key. The statement ID is a foreign key reference to the associated statement. The selected options are the options selected by the user during the interaction. The correctness is a boolean value indicating whether the user's response was correct or not. The timestamp is the date and time of the user interaction.

An analytics model 608 comprises a statement ID, total interactions, correct responses, and incorrect responses. The statement ID is a foreign key reference to the associated statement. The total interactions are the total number of interactions for the statement. The correct responses are the number of correct responses for the statement. The incorrect responses are the number of incorrect responses for the statement.

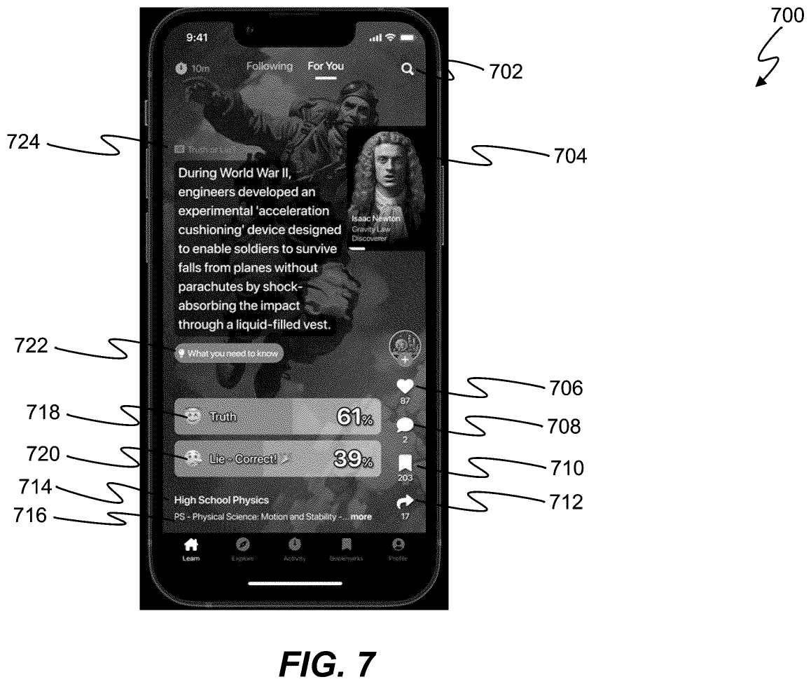

FIG. 7 is an exemplary user interface, 700 depicting interaction between the user and the online learning platform 102. A search button 702, located at the top-right corner of the user interface, serves as a search button. The search button 702 allows users to initiate a search within the application, providing them with the ability to explore various subjects, topics, and historical figures. A historical figure, 704, explains the topic through an educational video. A like button 706 allows the user to express interest and satisfaction with the content by clicking it if they like the information provided. A comment button 708 allows the user to comment on content. A save button 710 helps the user save content for future reference. For example, if the user wants to revisit the content later, they can click the save button 710 and watch it at their convenience. A forward button 712 allows the user to share the content with another user. For example, if a user finds the content relevant for someone else, they can forward it to that person using the forward button 712.

An educational statement 724 provides the user with a true or false statement. The true or false statement is randomly given by the educational statements 724. A ‘what you need to know’ button 722 provides information about the percentage selected statistics by the user. An answer-choose button comprises a truth option 718 and a lie option 720 allowing the user to respond to the educational statements 724 presented on the online learning platform 102. The user can click either the truth option 718 or the lie option 720. The truth option 718 or the lie option 720 also display the percentage of users who selected each option. Subject 714 and a detailed subject 716 provide information about the subject area to which the presented content belongs. For example, if the content on the online learning platform 102 covers acceleration cushioning, subject 714 would be displayed as High School Physics, and the detailed subject 716 would show Physical Science: Motion and Stability.

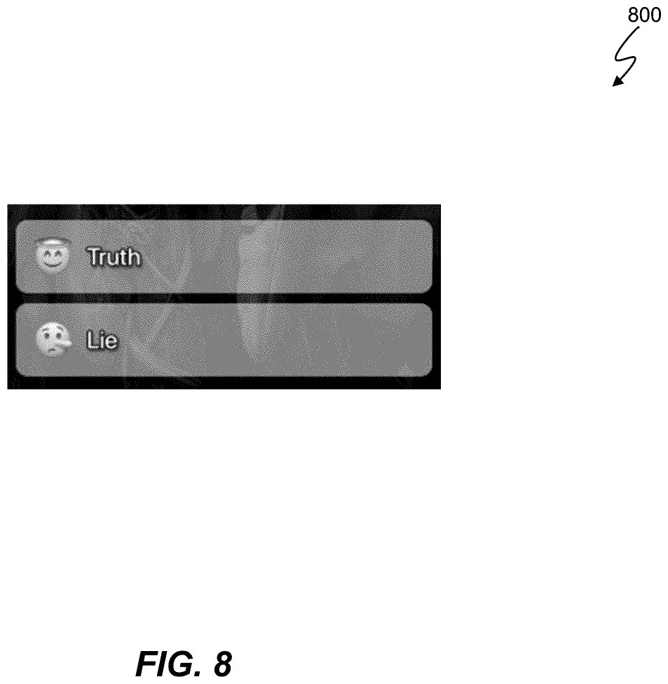

FIG. 8 depicts an exemplary user interface depicting answer choice buttons before the user selects an answer. The answer-choose button will always be displayed to the user through the online learning platform 102.

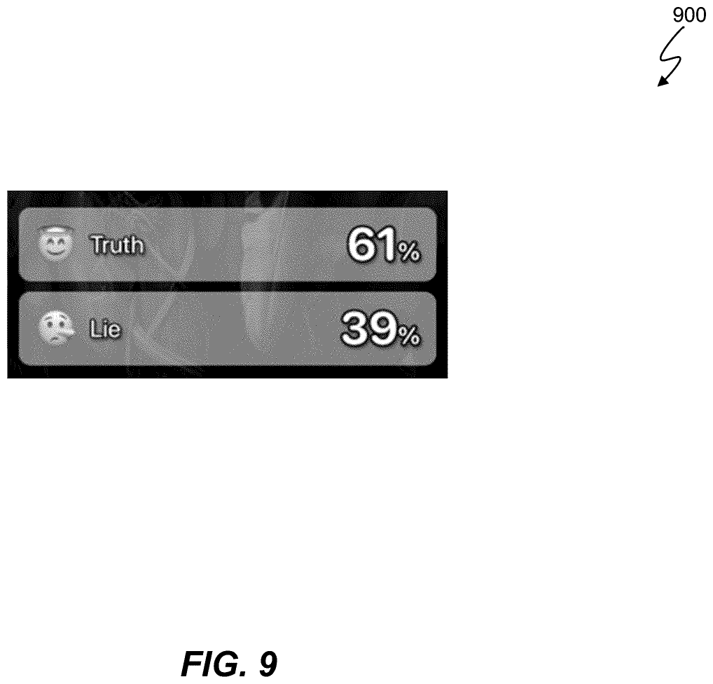

FIG. 9 depicts an exemplary user interface depicting answer choice buttons after the user clicks a “What you need to know” button but before the user selects an answer. If the user clicks the “What you need to know” button before clicking the answer choice button, the truth and lie percentage selected statistics will be displayed on the right side of the respective truth option 718 or lie option 720.

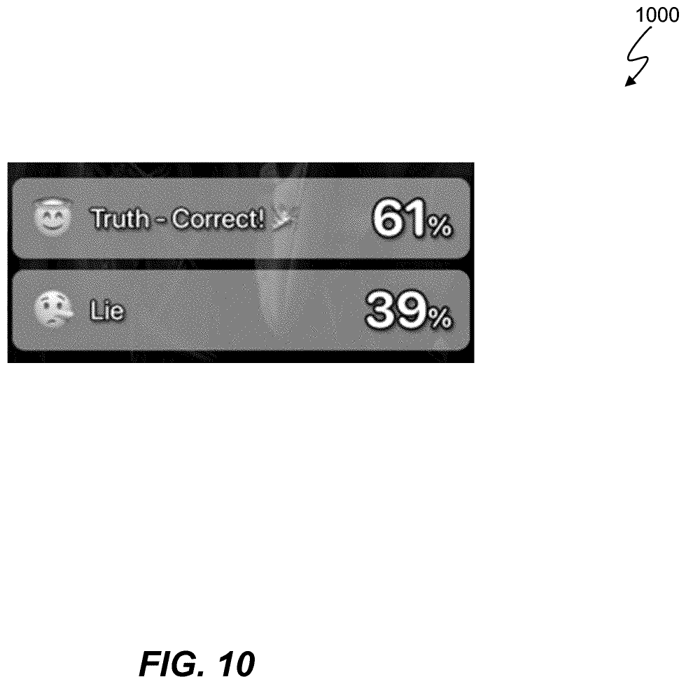

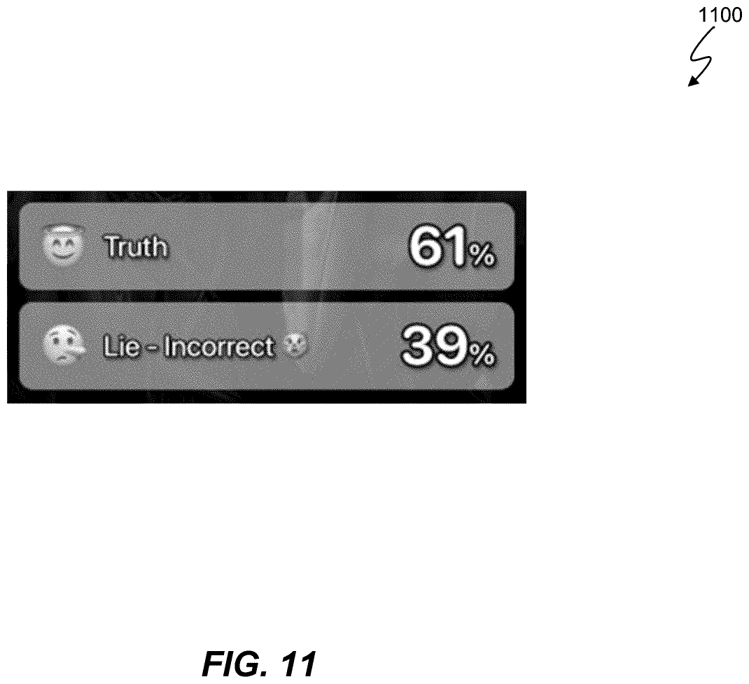

FIGS. 10 and 11 depict an exemplary user interface depicting answer choice buttons after the user clicks the correct answer or the wrong answer. If user selected the correct answer, then the selected answer choice button text should be updated to read “[ANSWER CHOICE]-Correct!” (FIG. 10). If the user selects the wrong answer, then the selected answer choice button text should be updated to read “[ANSWER CHOICE]: Incorrect” (FIG. 11). The percentage of selected statistics will be shown to the user after the user selects any of the options.

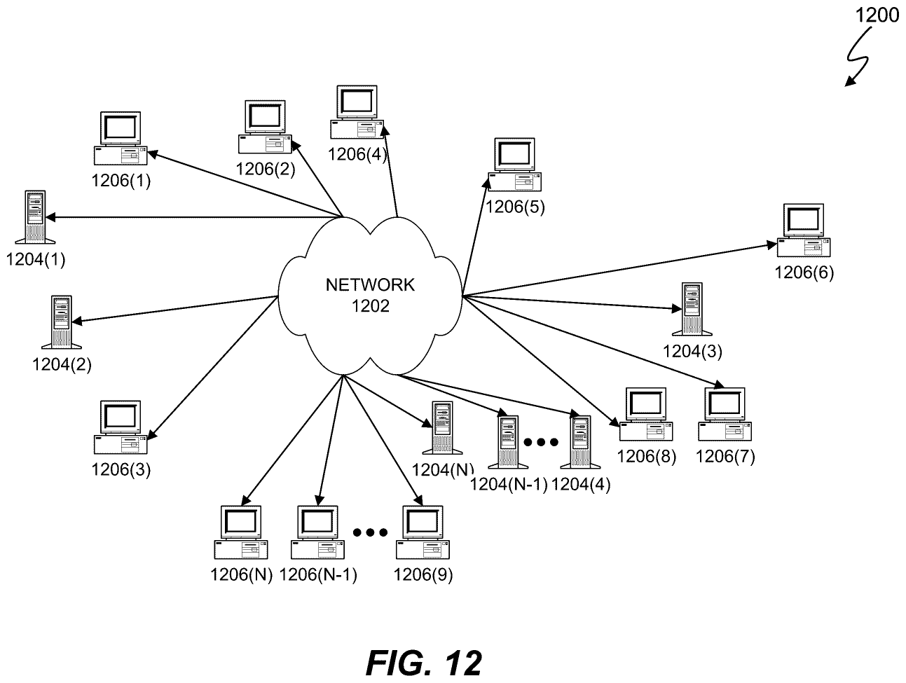

FIG. 12 is a block diagram illustrating a network environment in which an AI-driven statement truthfulness assessment system 100 and AI-driven statement truthfulness assessment process 200 may be practiced. Network 1202 (e.g. a private wide area network (WAN) or the Internet) includes a number of networked server computer systems 1204 (1)-(N) that are accessible by client computer systems 1206 (1)-(N), where N is the number of server computer systems connected to the network. Communication between client computer systems 1206 (1)-(N) and server computer systems 1204 (1)-(N) typically occurs over a network, such as a public switched telephone network over asynchronous digital subscriber line (ADSL) telephone lines or high-bandwidth trunks, for example communications channels providing T1 or OC3 service. Client computer systems 1206 (1)-(N) typically access server computer systems 1204 (1)-(N) through a service provider, such as an internet service provider (“ISP”) by executing application specific software, commonly referred to as a browser, on one of client computer systems 1206 (1)-(N).

Client computer systems 1206 (1)-(N) and/or server computer systems 1204 (1)-(N) are specialized computer programmed to improve conventional computer systems to implement and utilize the AI-driven statement truthfulness assessment system 100 and AI-driven statement truthfulness assessment process 200. The type of computer system that can be specially programmed to implement and utilize the AI-driven statement truthfulness assessment system 100 and AI-driven statement truthfulness assessment process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the 13AI-driven statement truthfulness assessment system 100 and AI-driven statement truthfulness assessment process 200 can be implemented using code stored in a tangible, non-transient computer readable medium and executed by one or more processors. In at least one embodiment, the 13AI-driven statement truthfulness assessment system 100 and AI-driven statement truthfulness assessment process 200 can be implemented completely in hardware using, for example, logic circuits and other circuits including field programmable gate arrays.

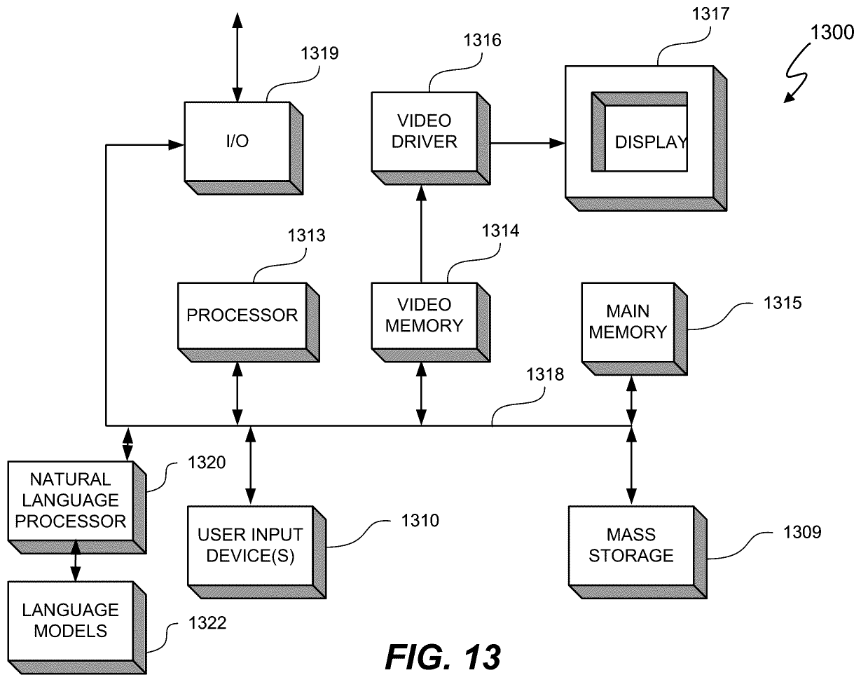

Embodiments of the 13AI-driven statement truthfulness assessment system 100 and AI-driven statement truthfulness assessment process 200 can be implemented on a computer system such as a special-purpose, special-programmed computer 1300 illustrated in FIG. 13. Input user device(s) 1310, such as a keyboard and/or mouse, are coupled to a bi-directional system bus 1318. The input user device(s) 1310 are for introducing user input to the computer system and communicating that user input to processor 1313. The computer system of FIG. 13 generally also includes a non-transitory video memory 1314, non-transitory main memory 1315, and non-transitory mass storage 1309, all coupled to bi-directional system bus 1318 along with input user device(s) 1310 and processor 1313. The mass storage 1309 may include both fixed and removable media, such as a hard drive, one or more CDs or DVDs, solid state memory including flash memory, and other available mass storage technology. Bus 1318 may contain, for example, 32 of 64 address lines for addressing video memory 1314 or main memory 1315. The system bus 1318 also includes, for example, an n-bit data bus for transferring DATA between and among the components, such as CPU 1309, main memory 1315, video memory 1314 and mass storage 1309, where “n” is, for example, 32 or 64. Alternatively, multiplex data/address lines may be used instead of separate data and address lines.

I/O device(s) 1319 may provide connections to peripheral devices, such as a printer, and may also provide a direct connection to a remote server computer systems via a telephone link or to the Internet via an ISP. I/O device(s) 1319 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1309, into main memory 1315 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1313, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1315 is comprised of dynamic random access memory (DRAM). Video memory 1314 is a dual-ported video random access memory. One port of the video memory 1314 is coupled to video amplifier 1316. The video amplifier 1316 is used to drive the display 1317. Video amplifier 1316 is well known in the art and may be implemented by any suitable means. This circuitry converts pixel DATA stored in video memory 1314 to a raster signal suitable for use by display 1317. Display 1317 is a type of monitor suitable for displaying graphic images.

The computer system described above is for purposes of example only. The 13AI-driven statement truthfulness assessment system 100 and AI-driven statement truthfulness assessment process 200 may be implemented in any type of computer system or programming or processing environment. It is contemplated that the 13AI-driven statement truthfulness assessment system 100 and AI-driven statement truthfulness assessment process 200 might be run on a stand-alone computer system, such as the one described above. The 13AI-driven statement truthfulness assessment system 100 and AI-driven statement truthfulness assessment process 200 might also be run from a server computer systems system that can be accessed by a plurality of client computer systems interconnected over an intranet network. Finally, the 13AI-driven statement truthfulness assessment system 100 and AI-driven statement truthfulness assessment process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method that integrates programmatic control and a guided and constrained Artificial Intelligence (AI) engine to generate an assessment of statement truthfulness for a user on an online learning platform comprising:
executing code using one or more processors of a computer system to cause the computer system to perform operations comprising:
receiving input data from a main data model and a (Truth or Lie) TOL data model by a content generation system, wherein the main data model includes educational standards, course information, and subject-specific data and the TOL data model includes name of historical figures, images of historical figures, and voice IDs associated with the historical figures;
selecting input data from the TOL data model based on a user data wherein the user data includes Course ID and a Standard ID provided by the user on the online learning platform wherein the selected data linked to corresponding data the main data model;
retrieving data from the TOL data model, wherein the retrieved data includes course-related information, standard descriptions, and attributes of historical figures;
generating a prompt using a prompt generator to guide the AI engine for generating the assessment of the education statement truthfulness;
transferring the prompt to the AI engine to utilize the retrieved data to produce the educational statements, wherein the education statement comprise truth and lie statement;
integrating an image generation model configured to generate images corresponding to the educational statements;
generating a video response by integrating a video generation model and a voice synthesis model, wherein the video response includes a historical figure narrating the context and explanation of the generated educational statements; and
displaying the generated educational statements, corresponding images, and the video response to the user on the online learning platform.

2. The method of claim 1 wherein the retrieved data includes images and voice IDs for the historical figures.

3. The method of claim 1 wherein the video generation model animates a representation of the historical figure by synchronizing the narration with the generated video response contextually aligned with the educational statements and providing an explanation and context behind each statement.

4. The method of claim 1 wherein employing a web technology to facilitate real-time user interactions, wherein the user is presented with the generated educational statements and the user is asked to select between truth or lie options.

5. The method of claim 4 wherein
dynamically updating the result to provide immediate feedback to the user on the correctness of the user choice, and
displaying the percentage of the other user who selected each option, thereby offering real-time comparative insights into the user decisions.

6. The method of claim 1 further comprising:
providing an info button on a user interface of the online learning platform to allow the user to know more about the generated educational statements, wherein on clicking the info button the video response is displayed featuring the historical figure explaining the educational statements.

7. The method of claim 1 further comprising:
utilizing a Large Language Model (LLM) by the AI engine for generating educational statements.

8. A system that integrates programmatic control and a guided and constrained Artificial Intelligence (AI) engine to generate an assessment of statement truthfulness for a user on an online learning platform comprising:
one or more processors of a computer system; and
a memory, coupled to the one or more processors, storing code that when executed causes the computer system to perform operations comprising:
receiving input data from a main data model and a TOL data model by a content generation system, wherein the main data model includes educational standards, course information, and subject-specific data and the TOL data model includes name of historical figures, images of historical figures, and voice IDs associated with the historical figures;
selecting input data from the TOL data model based on a user data wherein the user data includes Course ID and a Standard ID provided by the user on the online learning platform wherein the selected data linked to corresponding data the main data model;
retrieving data from the TOL data model, wherein the retrieved data includes course-related information, standard descriptions, and attributes of historical figures;
generating a prompt using a prompt generator to guide the AI engine for generating the assessment of the education statement truthfulness;
transferring the prompt to the AI engine to utilize the retrieved data to produce the educational statements, wherein the education statement comprise truth and lie statement;
integrating an image generation model configured to generate images corresponding to the educational statements;
generating a video response by integrating a video generation model and a voice synthesis model, wherein the video response includes a historical figure narrating the context and explanation of the generated educational statements; and
displaying the generated educational statements, corresponding images, and the video response to the user on the online learning platform.

9. The system of claim 8 wherein the retrieved data includes images and voice IDs for the historical figures.

10. The system of claim 8 wherein the video generation model animates a representation of the historical figure by synchronizing the narration with the generated video response contextually aligned with the educational statements and providing an explanation and context behind each statement.

11. The system of claim 8 wherein employing a web technology to facilitate real-time user interactions, wherein the user is presented with the generated educational statements and the user is asked to select between truth or lie options.

12. The system of claim 11 wherein
dynamically updating the result to provide immediate feedback to the user on the correctness of the user choice, and
displaying the percentage of the other user who selected each option, thereby offering real-time comparative insights into the user decisions.

13. The system of claim 8 further comprising:
providing an info button on a user interface of the online learning platform to allow the user to know more about the generated educational statements, wherein on clicking the info button the video response is displayed featuring the historical figure explaining the educational statements.

14. The system of claim 8 further comprising:
utilizing a Large Language Model (LLM) by the AI engine for generating educational statements.
